(19) United States
(12) Patent Application Publication
(10) Pub. No.: US 2006/0065626 A1
(43) Pub. Date: Mar. 30, 2006

(54) Detection and feed forward of exposed area to improve plasma etching

(76) Inventor: Michael C. Smayling, Fremont, CA (US)

Correspondence Address: Applied Materials;Patent Counsel - Legal Affairs Department, P.O. Box 450A, Santa Clara, CA, 95052, US

(21) Appl. No.: 10/952,353

(22) Filed: Sep. 27, 2004

(51) Int. Cl. G01L 21/30

(52) U.S. Cl. 216/60

(57) ABSTRACT

A method is provided for processing and etching a substrate with a patterned photoresist layer on its surface. In one aspect, a method is provided for processing a substrate including illuminating a substrate with ultraviolet light, emitting a fluorescent light from the photoresist layer, measuring the intensity of the emitted fluorescent light and determining the open area percentage value for the patterned substrate. In another aspect, a method is provided for processing a substrate including providing the substrate, measuring the open area percentage value for the substrate, transmitting the open area percentage value to a processor, selecting an etch process for the substrate, transferring the substrate to a processing chamber, and etching the substrate.

### BACKGROUND OF THE INVENTION

1. Field of the Invention

Embodiments of the present invention generally relate to the fabrication of integrated circuits and to the fabrication of photomasks used in the fabrication of integrated circuits.

2. Description of the Related Art

Semiconductor device geometries have dramatically decreased in size since such devices were first introduced several decades ago. Since then, integrated circuits have generally followed the two year/half-size rule (often called Moore's Law), which means that the number of devices on a chip doubles every two years. Today's fabrication plants are routinely producing devices having 0.15 μm and even 0.13 μm feature sizes, and tomorrow's plants soon will be producing devices having even smaller geometries.

The increasing circuit densities have placed additional demands on processes used to fabricate semiconductor devices. For example, as circuit densities increase, the widths of vias, contacts and other features, as well as the dielectric materials between them, decrease to sub-micron dimensions, whereas the thickness of the dielectric layers remains substantially constant, with the result that the aspect ratios for the features, i.e., their height divided by width, increases. Reliable formation of high aspect ratio features is important to the success of sub-micron technology and to the continued effort to increase circuit density and quality of individual substrates.

High aspect ratio features are conventionally formed by patterning a surface of a substrate to define the dimensions of the features and then etching the substrate to remove material and define the features. To form high aspect ratio features with a desired ratio of height to width, the dimensions of the features are required to be formed within certain parameters, which are typically defined as the critical dimensions of the features. Consequently, reliable formation of high aspect ratio features with desired critical dimensions requires precise patterning and subsequent etching of the substrate.

Photolithography techniques, as one conventional method of patterning resists for etching processes, use light patterns and photoresist materials deposited on a substrate surface to develop precise patterns on the substrate surface prior to the etching process. Photolithographic reticles, or photomasks, typically include a substrate made of an optically transparent silicon based material, such as quartz (i.e., silicon dioxide, SiO₂), having an opaque light-shielding layer of metal, typically chromium, patterned on the surface of the substrate. The patterned metal layer, or photomask layer, define the pattern and correspond to the dimensions of the features to be transferred to the substrate when exposing a photoresist material to a pattern of light through a photolithographic photomask which corresponds to the desired configuration of features. A light source emitting ultraviolet (UV) light, for example, may be used to expose the photoresist to alter the composition of the photoresist. Generally, the exposed photoresist material is removed by a chemical process to expose the underlying substrate material. The exposed underlying substrate material is then etched to form the features in the substrate surface while the retained photoresist material remains as a protective coating for the unexposed underlying substrate material. The exposed underlying material to be etched may be a metal layer or may be a dielectric material.

As a substrate enters the etching process, an etching process or recipe must be determined for each pattern design. Depending on the material to be etched and the pattern density of the substrate, different etch process with differing compositions may be used to optimize etch performance. Manual determination of the etch process reduces substrate throughput. Previous methods of determining and implementing etch processes have been less than satisfactory.

Therefore, there remains a need for an improved etch process with higher throughput, which can inspect the substrate and determine the optimal etch process to be utilized.

### SUMMARY OF THE INVENTION

The present invention generally provides a method for processing and etching a substrate. In one aspect, a method is provided for processing a substrate including introducing a substrate having a surface comprising a patterned photoresist layer, illuminating the substrate with an ultraviolet light, emitting fluorescent light from the photoresist layer, measuring the intensity of the emitted fluorescent light, and determining an open area percentage value for the substrate from the intensity of the emitted fluorescent light.

In another aspect, a method is provided for etching a substrate including providing a first substrate having a surface comprising a patterned photoresist layer; measuring an open area percentage value for the first substrate, transmitting the open are percentage value to a processor, selecting an etch process for the open area percentage value from a database coupled to the processor containing a plurality of etch processes, transferring the first substrate to a processing chamber, and etching the first substrate with the selected etch process.

In yet another aspect, a method is provided for etching a substrate including introducing a first substrate having a surface comprising a patterned photoresist layer, illuminating the substrate with an ultraviolet light, emitting a fluorescent light from the photoresist layer, measuring the intensity of the emitted fluorescent light, transmitting the open area percentage value to a processor, determining an open area percentage value for the first substrate from the intensity of the emitted fluorescent light, selecting an etch process for the open area percentage value from a database coupled to the processor containing a plurality of etch processes, and etching the substrate with the selected etch process.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of a system for use with the processes described herein;

FIG. 2 is a schematic view of a front end metrology device for use with the processes described herein; and

FIG. 3 is a flow chart illustrating one embodiment of a sequence for processing a substrate.

### DETAILED DESCRIPTION

The present invention is described with reference to processing and etching a substrate, for example, to improve etch performance and substrate throughput. The determination of the open area percentage value for a substrate allows an optimized etch process to be selected. The open area percentage value for a substrate with a patterned photoresist layer covering a portion of its surface is the ratio of the exposed surface area of the substrate to the entire surface area of the substrate, where the exposed portion of the substrate is to be etched.

Apparatus

Suitable reactors that may be adapted for use with the teachings disclosed herein include, for example, the Decoupled Plasma Source (DPS™) II reactor, or the Tetra I and Tetra II Photomask etch systems, all of which are available from Applied Materials, Inc. of Santa Clara, Calif. The DPS™ II reactor may also be used as a processing module of a Centura™ integrated semiconductor wafer processing system, also available from Applied Materials, Inc.

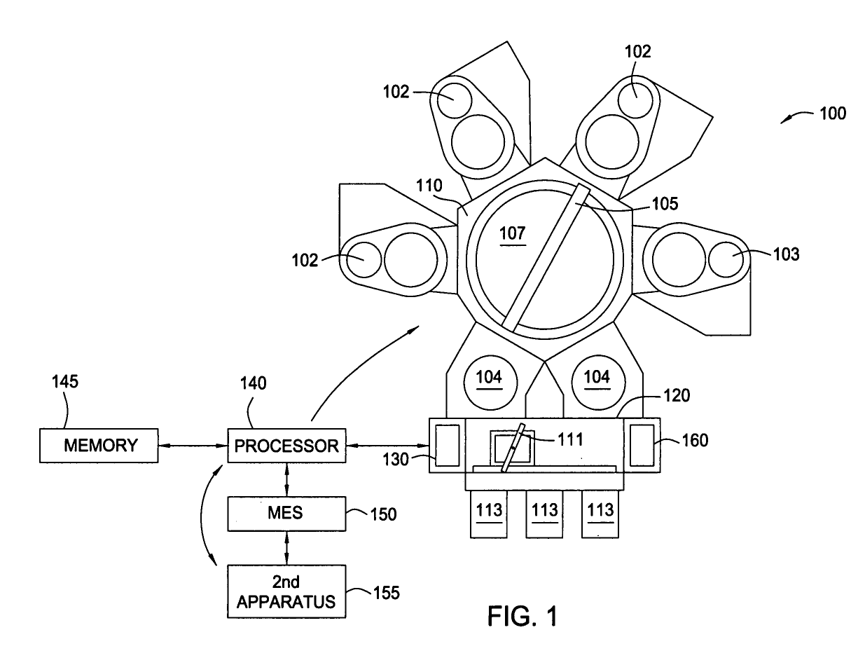

FIG. 1 is depicts a schematic diagram of one embodiment of an etch system 100. The particular components of the etch system 100 shown herein are provided for illustrative purposes and should not be used to limit the scope of the invention.

The system 100 generally includes an etch mainframe or etch platform 110, a front end staging area 120, a front-end metrology device 130, a processor 140 that performs the analysis disclosed herein electronically, a computer software-implemented database system 150, known as a manufacturing execution system (MES) conventionally used for storage of process information; and a post etch metrology device 160.

A substrate is introduced into the system 100 through the front end staging area 120, a loading area, which is generally known as a factory interface or mini environment. As shown in FIG. 1, the front end staging area 120 is coupled to a transfer chamber 107 of the etch platform 110 by one or more loadlock chambers 104. The front-end staging area 120 includes one or more cassette holders 113, a robot 111, for transferring a substrate to the loadlock chambers 104.

The front end staging area may further include a front-end metrology device 130 and/or a post etch metrology device 160. The front-end metrology device 130 inspects the substrate prior to etching to determine the open area percentage value for the substrate. Additionally, the front-end metrology device 130 may inspect the substrate by processes described herein after it has been etched and or cleaned to ensure all of the photoresist has been removed. The metrology device 130 may alternatively be a stand-alone device.

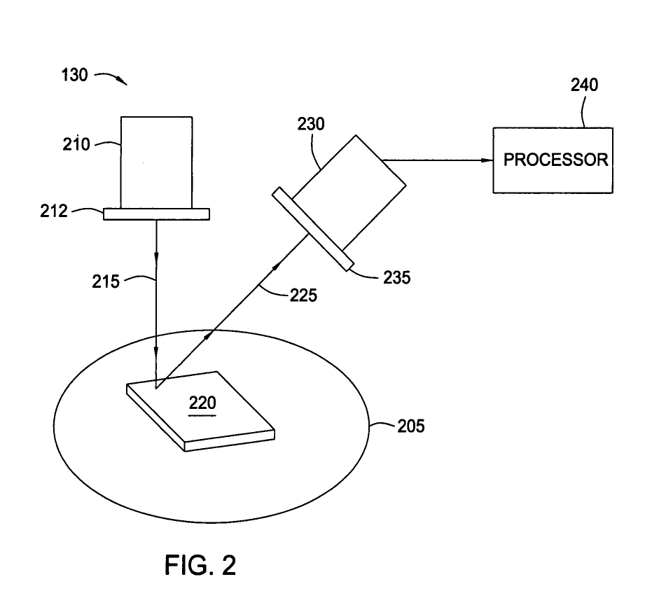

Referring to a schematic view of one embodiment of a front-end metrology device 130, FIG. 2 depicts. The front end metrology device 200 generally includes a stage 205, a light source 210 and sensing equipment 230. The front-end metrology device 130, as described herein may rapidly process and/or inspect a substrate 220 having a surface that includes a patterned photoresist layer and determine the open area percentage value for the substrate 220. While the substrate 220 shown in FIG. 2 is square-shaped (rectangular of equal length sides), such as used in photolithographic reticle manufacturing, the invention contemplates that substrates of various sizes and various shapes, such as circular substrate for chip manufacturing and rectangular shapes having different side lengths, such as used in some liquid crystal displays, may be used with the invention herein. The embodiment of the front-end metrology device 130 shown herein is provided for illustrative purposes and the description should not be construed or interpreted to limit the scope of the invention.

The light source 210 generates an initial light beam 215 directed onto the substrate 220 that is mounted on a stage 205. The light source 210 emits light with an ultraviolet light wavelength. The ultraviolet light wavelength may vary in length. The ultraviolet light wavelength is of a wavelength that is typically inert to reaction with the photoresist layer. Photoresist materials are designed to be sensitive to wavelengths of a desired ultraviolet light to have precise reactions to form regions of modified resist material that are etched to produce feature definitions of a desired critical dimension in the photoresist material.

Preferred ultraviolet light wavelengths for measurement by the process herein are the ultraviolet light wavelengths that the photoresist is insensitive to chemical reaction. For example, photoresist may be sensitive to ultraviolet light having wavelengths of about 250 nanometers or less, for example, 248 nanometers, 193 nanometers, and 157 nanometers, and suitable ultraviolet light wavelengths for emission for the process described herein are about 300 nanometers or greater, such as between about 300 nanometers and about 525 nanometers. Ultraviolet light wavelengths ranging from 300 nanometers to 525 nanometers may be emitted by a high energy or high intensity source, such as a xenon, mercury, or other filtered arc lamps, or a HeCd or Ar-ion laser. The invention contemplates that different ranges of ultraviolet light may be used to provide an inert ultraviolet light wavelength to photoresist having different wavelength sensitivities, such as photoresists having sensitivities of 365 nanometers or 430 nanometers.

Suitable ultraviolet light wavelengths are provided at sufficient intensity to produce a corresponding fluorescent light intensity between about 0.1% and about 1% of the ultraviolet light intensity. For example, the ultraviolet light may be provided at an intensity of at least 1 milliwatt per square centimeter, such as between about 1 milliwatt per square centimeter and about 100 milliwatts per square centimeter to produce a measurable fluorescent light intensity. The invention further contemplates that the sensitivity of detectors may be adjusted or provided that would allow fluorescent light intensity measurements beyond the described intensity between about 0.1% and about 1% of the ultraviolet light intensity.

Once generated, the initial light beam 215 may pass through an excitation filter 212 prior to illuminating the substrate 220. When the beam passes through the excitation filter 212, wavelengths of light that will not cause the photoresist layer to emit fluorescent light may be removed. The initial light beam 215 may be reflected off of the dichromatic mirror (not shown) to direct the light beam onto the substrate 220. Further, the initial light beam 215 may optionally pass through a beam expander (not shown) so that the entire surface of the substrate may be illuminated at one time.

A secondary light beam 225 of fluorescent light is emitted from the photoresist layer on the substrate. The secondary light beam 225 of fluorescent light has a longer wavelength than the light beam 225. Prior to being measured by the sensing equipment 230, the secondary light beam 225 may pass through a suppression filter 235 to absorb undesired emitted light. The sensing equipment 230 senses the secondary light beam 225 with a light intensity sensor, such as a silicon diode sensor, as an electronic intensity signal. This signal is converted into a numerical value, such as a digital or analog value, that can be transmitted to the processor 240 for analysis. Additionally, other lens and filters (not shown) may be incorporated into the above described device for enhancing, filtering, directing, and otherwise improving performance of the light beam.

Referring back to FIG. 1, the post etch metrology device 160 may be any inspection apparatus, film thickness, or critical dimension (CD) metrology apparatus, including a phase angle measurement apparatus and/or a fluorescent light detector apparatus. The fluorescent light detector may be the same as used for the front end metrology device 130. One example of an inspection apparatus is the Excite™ inspection apparatus available from Applied Materials, Inc., of Santa Clara, Calif.

Alternatively, the post etch metrology device may be a stand-alone device. While the post etch metrology device is shown coupled to the load lock chambers 104, the device may be incorporated into other areas of the system 100 with high-speed data collection and analysis capabilities. An exemplary example of a stand alone device is the VeraSEM 3D from Applied Materials, Inc., of Santa Clara, Calif.

The etch platform 110 includes a transfer chamber 107 and one or more processing chambers, or etching chambers 102. Alternatively, a post-etch cleaning chamber (not shown) may also be included in the etch platform 110. A robot 105 disposed in the transfer chamber 107 transfers a substrate 222 between the load lock chambers 104, processing chambers 102, and any other processing chambers disposed on the platform 110, such as the mentioned post-etch cleaning chamber.

A processor 140 is coupled to the system 100 and includes or is coupled to a database that contains a plurality of etch processes which may be used to etch the substrate. Processor 140 can be a controller including a central processing unit (CPU), support circuits and memory. The CPU is generally one or more processors, microprocessors, or micro-controllers that operate in accordance with instructions that are stored in memory. Support circuits are coupled to the CPU for supporting the processor in a conventional manner. Support circuits include cache, power supplies, clock circuits, input/output circuitry and subsystems, and can include input devices used with the controller, such as keyboards, trackballs, a mouse, and display devices, such as computer monitors, printers, and plotters. Such controllers are commonly known as personal computers; however, the present invention is not limited to personal computers and can be implemented on workstations, minicomputers, mainframes, and supercomputers. Memory comprises random access memory, read only memory, removable memory, disk drives, or combinations thereof. The memory stores various types of software including equipment control software and design intent parameters.

The controller 140, when executing equipment control software, sends a control message to various processing equipment within the system of FIG. 1. The processor 140 can be in communication with a computer software-implemented database system 150 known as the “manufacturing execution system” (MES), as well as additional processing equipment, such as a second processing system 155, including an additional etch platform 110. The computer software-implemented database system 150 stores and transmits substrate processing information and may additionally be in communication with the second processing equipment 155.

A process, for example an etching process described below, is generally stored in the memory 145, typically as a software routine. The software routine may also be stored and/or executed by a second CPU that is remotely located from the hardware being controlled by the CPU.

The processes described herein may be implemented as a computer program-product for use with a computer system or computer based controller. The programs defining the functions of the preferred embodiment can be provided to a computer via a variety of signal-bearing media and/or computer readable media, which include but are not limited to, (i) information permanently stored on non-writable storage media (for example, read-only memory devices within a computer such as read only CD-ROM disks readable by a CD-ROM or DVD drive; (ii) alterable information stored on a writable storage media (for example, floppy disks within diskette drive or hard-disk drive); or (iii) information conveyed to a computer by communications medium, such as through a computer or telephone network, including wireless communication. Such signal-bearing media, when carrying computer-readable instructions that direct the functions of the invention, represent alternative embodiments of the present invention. It may also be noted that portions of the product program may be developed and implemented independently, but when combined together are embodiments of the present invention.

Processing of a Substrate

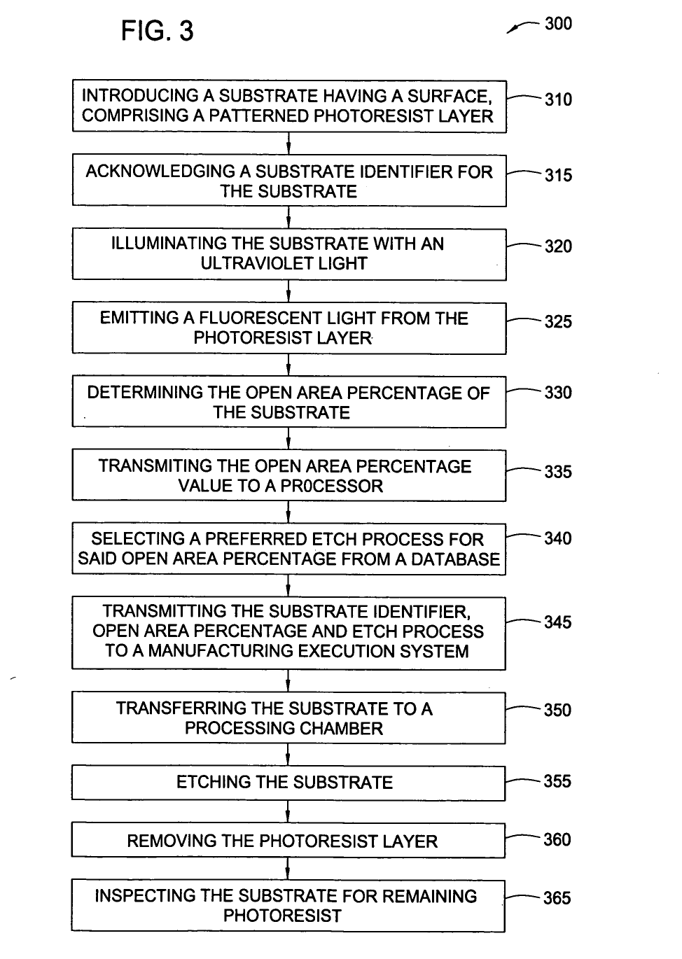

FIG. 3 depicts a flow chart of one embodiment of a process sequence 300, which may use the devices of FIGS. 1 and 2. The flow chart is provided for illustrative purposes and should not be construed or interpreted as limiting the scope of the invention.

A substrate 220, such as a photolithographic reticle, having a patterned photoresist layer disposed thereon is introduced to the system 100 at step 310, specifically to the front-end metrology device 130 of FIG. 1. The front-end metrology device 130 acknowledges a substrate identifier for the substrate to be stored by the computer software-implemented database system 150 at step 315. This substrate identifier can be attached to other substrates within the same batch with the same pattern density as the first substrate for future or parallel processing, eliminating the need to inspect every substrate within the batch.

When the substrate 220 is placed in the front-end metrology device 130, it is illuminated with the initial light beam 215 that is generated by the light source 210 at step 320. The initial light beam 215 must be of sufficient intensity and wavelength so as to cause the photoresist layer upon the substrate 220 to emit a secondary light beam 225 of fluorescent light at step 325. The primary light beam may optionally be filtered, reflected or expanded prior to hitting the substrate 220.

The front end metrology device 130 may operate by either a rapid inspection process or a rastering process. In a rapid inspection process the light source 210 illuminates the entire surface of substrate 220 with an exposure of light less than about 1 second in duration, preferably less than about 0.1 second in duration. The light beam generated may be passed through a beam expander so that the entire substrate may be illuminated at one time. In a rastering process, the light source 210 illuminates the substrate 220 by scanning small portions of the substrate 220. The intensity of the emitted fluorescent light is calculated from the summation of the individual intensity values measured for each small portion of the substrate.

The fluorescent light emitted from the photoresist layer ranges between about 550 nanometers and about 850 nanometers, such as between about 600 nanometers and about 800 nanometers with an intensity of at least 1 microwatt per square centimeter, such as between about 1 microwatt per square centimeter and about 10 milliwatts per square centimeter, for example, between about 50 microwatts per square centimeter and about 100 microwatts per square centimeter. The secondary light beam 225 may be filtered to reduce or eliminate any wavelengths of light that were not emitted from the photoresist layer to produce a filtered light beam that is substantially free of undesired wavelengths. The sensing equipment 230 measures the intensity of the filtered light beam. From the intensity of the filtered light beam, the open area percentage value for the substrate 220 can be determined by the processor 140 at step 330.

The open area percentage value is determined by comparing the measured intensity of the filtered light to a calibration curve. A calibration curve is initially determined for the substrates to be processed, and may be done for every batch of substrates processed. The calibration curve may be a pre-determined set of values stored in a database from prior processing of similar substrates.

The calibration curve measurement utilizes the same process as described above, except that it uses substrates with known open area percentage values. A substrate with no photoresist upon its surface (open area percentage=100%) and a substrate surface completely covered in photoresist (open area percentage=0%) are respectively measured. Additionally, the calibration is not limited to the use of these two percentages of photoresist coverage. Substrates with other known open area percentages, for example, open area percentages of 30% and 60%, 25%, 50%, and 75% or 20%, 40%, 60% and 80% may be used in the calibration. Furthermore, the intensity of light emitted from a photoresist may vary or remain consistent with the thickness of the photoresist layer and the open are percentage. The calibration curve may be adapted to reflect the changing light intensities for varying photoresist thicknesses having the same and different open area percentage. For example, a photoresist layer of 3000 nanometers in thickness with an open area percentage of 50% will emit a fluorescent beam of about the same intensity as a layer of 6000 nanometers with an open area percentage of 25%.

The calibration curve determined by the processor 140 may be analog or digital. Once the calibration is complete, the measured intensity of emitted fluorescent light from substrate 220 is applied to the calibration to produce a value of the pattern density or open area percentage value for the substrate 220, which is transmitted to processor 140 at step 335.

Processor 140 also contains a database of etch processes. The plurality of etch processes contained within the database are pre-established to correspond to particular range of open area percentages. The calculated open area percentage for substrate 220 is transmitted to an advanced process control algorithm within the processor 140 to select the optimized etch process to be used in processing the substrate 220 at step 340. Any suitable dielectric etch process for substrate, such as etching to form feature definitions in dielectric materials for damascene application as well as metal etching processes, such as photomask etching for use in photolithographic reticles, that use patterned photoresist materials may be used by this invention. The invention also contemplates application of processes herein to other resist materials, such as e-beam resists, that are capable of emitting fluorescent light, whether from ultra-violet light or other light source, for measurement in the device described herein.

The substrate parameters, including the open area percentage value for the substrate 220, the optimal etch process, and the substrate identifier, are transmitted to the processor 140 to be sent to memory device 145 and to the computer software-implemented database system 150 for storage of the information at step 345. In essence, the substrate parameters are supplied to the controller to facilitate creation of substrates that inform the processing apparatus of what they are actually making such that they may efficiently optimize the product. These parameters may be supplied to other processing equipment to facilitate an increase in substrate throughput.

If the front-end metrology device is incorporated in the front-end staging area, a robot 111 then transfers the substrate 220 into a loadlock chamber 104. If the front-end metrology device 130 is a stand-alone apparatus, the substrate 220 then is moved to the front-end staging area 120 prior to being transferred into a loadlock chamber 104 by robot 111. At step 355, a robot 105 moves the substrate 220 from the loadlock chamber 104 into a processing chamber 102. In the processing chamber 102, the substrate 200 may be etched with the selected etch process at step 355. After etching, the substrate 220 may be transferred to the endpoint metrology device 160 for post-etch inspection. Alternatively, it may be first transferred to a post-etch cleaning chamber 103 for removal of any remaining photoresist layer at step 360 and then transferred to the endpoint metrology device 160. The endpoint metrology device 160 may measure the etched substrate's critical dimension bias or sidewall angle or detect if there is any photoresist remaining on the substrate 220 at step 365. Alternatively, the front-end metrology device 130 may be used to inspect the etched substrate for any remaining photoresist by illuminating the etched substrate with an ultraviolet light and detecting whether the substrate 220 fluoresces, which would indicate the presence of remaining photoresist.

While the methods, as described herein, are described with reference to photolithography, they can also be useful for related processes such as the formation of dual damascenes, thin film transistors, and shallow trench isolation structures.

While the foregoing is directed to embodiments of the present invention, other and further embodiments of the invention may be devised without departing from the basic scope thereof, and the scope thereof is determined by the claims that follow.

What is claimed is:

1. A method for processing a substrate, comprising:
introducing a substrate having a surface comprising a patterned photoresist layer;
illuminating the substrate with an ultraviolet light;
emitting a fluorescent light from the photoresist layer;
measuring the intensity of the emitted fluorescent light; and
determining an open area percentage value for the substrate from the intensity of the emitted fluorescent light.

2. The method of claim 1, wherein illuminating the substrate with an ultraviolet light further comprises filtering the ultraviolet light.

3. The method of claim 1, wherein measuring the intensity of the emitted fluorescent light further comprises filtering the emitted fluorescent light to isolate the emitted fluorescent light.

4. The method of claim 1, wherein fluorescent light has a wavelength longer than the ultraviolet light wavelength.

5. The method of claim 4, wherein the photoresist material is insensitive to the wavelength of the ultraviolet light.

6. The method of claim 4, wherein the photoresist layer is sensitive to ultraviolet light having wavelengths of about 250 nanometers or less, the ultraviolet light has a wavelength within the range between about 300 and about 525 nanometers, and the fluorescent light has a wavelength within the range of 550 to 850 nanometers.

7. The method of claim 1, further comprising etching the substrate.

8. The method of claim 7, further comprising inspecting the substrate with a fluorescent light detector.

9. A method of etching a substrate, comprising:
providing a first substrate having a surface comprising a patterned photoresist layer;
measuring an open area percentage value for the first substrate;
transmitting the open area percentage value to a processor;
selecting an etch process for the open area percentage value from a database coupled to the processor containing a plurality of etch processes
transferring the first substrate to a first processing chamber; and
etching the first substrate with the selected etch process.

10. The method of claim 9, wherein measuring the open area percentage value for the first substrate further comprises illuminating the first substrate by a flash process.

11. The method of claim 9, wherein measuring the open area percentage value for the first substrate further comprises illuminating the first substrate by a rastering process.

12. The method of claim 9, wherein each of the plurality of etch processes corresponds to a particular range of open area percentages.

13. The method of claim 9, wherein providing a first substrate having a surface comprising a patterned photoresist layer further comprises acknowledging a substrate identifier for the substrate.

14. The method of claim 13, further comprising transmitting the substrate identifier, open area percentage value and etch process for the substrate to a manufacturing execution system for transmission to a second processing chamber and processing a second substrate having a surface comprising a patterned photoresist layer.

15. The method of claim 13, further comprising transmitting the substrate identifier, open area percentage value and etch process for the substrate to a manufacturing execution system for transmission to a second processing chamber and processing the first substrate having a surface comprising a patterned photoresist layer.

16. A method for etching a substrate, comprising:
introducing a first substrate having a surface comprising a patterned photoresist layer;
illuminating the first substrate with an ultraviolet light;
emitting a fluorescent light from the photoresist layer;
measuring the intensity of the emitted fluorescent light
determining an open area percentage value for the first substrate from the intensity of the emitted fluorescent light;
transmitting the open area percentage value to a processor;
selecting an etch process for the open area percentage value from a database coupled to the processor containing a plurality of etch processes; and
etching the first substrate with the selected etch process.

17. The method of claim 16, wherein each of the plurality of etch processes corresponds to a particular range of open area percentages.

18. The method of claim 16, wherein providing a first substrate having a surface comprising a patterned photoresist layer further comprises acknowledging a substrate identifier for the first substrate.

19. The method of claim 18, further comprising transmitting the substrate identifier, open area percentage value and etch process for the substrate to a manufacturing execution system for transmission to a second processing chamber and processing a second substrate having a surface comprising a patterned photoresist layer.

20. The method of claim 18, further comprising transmitting the substrate identifier, open area percentage value and etch process for the substrate to a manufacturing execution system for transmission to a second processing chamber and processing the first substrate having a surface comprising a patterned photoresist layer.

21. The method of claim 16, further comprising inspecting the first substrate for the presence of the photoresist layer.

22. The method of claim 16, further comprising removing the photoresist layer.

23. The method of claim 22, further comprising inspecting the first substrate for the presence of the photoresist layer.
